(19) United States
(12) Patent Application Publication
(10) Pub. No.: US 2026/0352339 A1
(43) Pub. Date: Nov. 5, 2026

(54) RECEPTION APPARATUS, QUANTUM KEY DISTRIBUTION SYSTEM, AND METHOD FOR RECEIVING QUANTUM SIGNAL

(71) Applicant: NEC Corporation, Tokyo (JP)

(72) Inventor: Ken-ichiro YOSHINO, Tokyo (JP)

(73) Assignee: NEC Corporation, Tokyo (JP)

(21) Appl. No.: 19/642,894

(22) Filed: Apr. 9, 2026

(30) Foreign Application Priority Data
Apr. 22, 2025 (JP) 2025-070737
Aug. 29, 2025 (JP) 2025-143757

(51) Int. Cl. H04B 10/54; H04B 10/70

(52) U.S. Cl. CPC H04B 10/54; H04B 10/70

(57) ABSTRACT

An object of the present disclosure is to prevent an eavesdropping attack on quantum key distribution. An optical intensity modulator performs intensity modulation on an incident quantum signal. A photon detection apparatus detects photons of the quantum signal modulated by the optical intensity modulation unit by any of a plurality of detectors. A controller controls the intensity modulation of the quantum signal in the optical intensity modulation unit in such a way that the quantum signal is incident on the plurality of detectors in a period in which variation in detection efficiency of the quantum signal in the plurality of detectors is within a predetermined range.

### INCORPORATION BY REFERENCE

This application is based upon and claims the benefit of priority from Japanese patent application No. 2025-70737, filed on Apr. 22, 2025, and No. 2025-143757, filed on Aug. 29, 2025, the disclosure of which is incorporated herein in its entirety by reference.

### TECHNICAL FIELD

The present disclosure relates to a reception apparatus, a quantum key distribution system, and a method for receiving a quantum signal.

### BACKGROUND ART

With the spread of the Internet, there is an increasing social need for encryption technology such as secrecy and tamper prevention of communication and personal authentication. From such a background, in order to ensure communication security, the use of the quantum key distribution technology, which is a technology for sharing a secure secret key including random numbers between remote locations, is in the spotlight because it makes eavesdropping difficult in principle (WO 2022/163577 A1).

In quantum key distribution, a quantum signal is generally transmitted from a transmission apparatus to a reception apparatus, and the quantum signal is detected using a plurality of photon detectors provided in the reception apparatus. In this case, if there is a variation (deviation) in detection efficiency between the photon detectors, the variation in detection efficiency may be used in eavesdropping. In the encryption technology, eavesdropping using such deviation in information is widely known. Therefore, it is known that it is preferable that the photon detectors have uniform detection efficiency to suitably prevent eavesdropping.

In quantum key distribution, various eavesdropping attempts such as side channel attacks have been made on quantum cryptographic communications using quantum keys. Among them, there is known an eavesdropping technique called a time shift attack (Bing Qi, et Al., “TIME-SHIFT ATTACK IN PRACTICAL QUANTUM CRYPTOSYSTEMS”, 2007, Quantum Information and Computation, vol. 7, pp. 073-082) in which an eavesdropper performs eavesdropping by manipulating an arrival time of a quantum signal to a photon detector without directly eavesdropping on the quantum signal by utilizing vulnerability of the photon detector that detects the quantum signal.

### SUMMARY

In general, in quantum key distribution, a plurality of photon detectors is used to detect a quantum signal. Ideally, the quantum signal is carried by one photon, but actually, the quantum signal may be carried by two or more photons. However, since the intensity of the quantum signal is weak in any case, an avalanche photodiode (APD) capable of amplifying the received weak signal and outputting the amplified signal is used for a photon detector.

In the APD, an electron avalanche phenomenon results from electrons generated at the time of incidence of a photon in a state where a reverse bias exceeding a breakdown voltage is applied, which makes it possible to amplify a signal. Therefore, in quantum key distribution, a high reverse bias voltage is applied to the APD in such a way that its application timing is synchronized with a timing at which a photon of the quantum signal is incident (e.g., WO 2022/163577 A1). FIG. 19 is a diagram schematically illustrating a timing at which a voltage is applied to an APD and a degree of dependence of photon detection efficiency on time. In a case where the timing at which the reverse bias is applied to the APD coincides with the timing at which the photon is incident, the photon detection efficiency of the APD is maximized. However, it is known that, in a case where there is a time difference between the timing at which the reverse bias is applied to the APD and the timing at which the photon is incident, the detection efficiency of the APD decreases as the time difference increases. That is, the photon detection efficiency of the APD depends on the timing at which the photon is incident.

In quantum key distribution, while a plurality of photon detectors (APD) is used, it is preferable that the photon detectors have the same photon detection efficiency to ensure high security. However, the photon detectors have individual differences in degree of dependence of photon detection efficiency on incident timing. FIG. 20 is a diagram illustrating examples of degrees of dependence of photon detection efficiency on incident timing in a plurality of photon detectors. In the examples illustrated in FIG. 20, bits 0 and 1 of the X base and bits 0 and 1 of the Z base are detected by four photon detectors. As illustrated in FIG. 20, even though photons are incident at the same timing (e.g., timing T in FIG. 20), photon detection efficiency varies between the plurality of photon detectors.

Each of the plurality of photon detectors is assigned to a respective one of bits of one of the bases of the quantum signal. If there is variation in degree of dependence of photon detection efficiency on incident timing between the photon detectors, for example, as the time shift attack, the detection efficiency of each bit of each base is analyzed, and as a result, a situation in which eavesdropping is permitted may occur. Therefore, it is required to prevent or suppress the influence of degree of dependence of photon detection efficiency on incident timing in the photon detector.

A reception apparatus according to an example aspect of the present disclosure includes optical intensity modulation means for intensity-modulating an incident quantum signal, photon detection means for detecting photons of the quantum signal that has been intensity-modulated by the optical intensity modulation means by any of a plurality of detectors, and control means for controlling the intensity modulation of the quantum signal in the optical intensity modulation means in such a way that the quantum signal is incident on the plurality of detectors in a period in which variation in detection efficiency of the quantum signal in the plurality of detectors falls within a predetermined range.

A quantum key distribution system according to an example aspect of the present disclosure includes a transmission apparatus for transmitting a quantum signal for quantum key distribution, and a reception apparatus for receiving the quantum signal, in which the reception apparatus includes optical intensity modulation means for intensity-modulating the quantum signal incident from the transmission apparatus, photon detection means for detecting photons of the quantum signal that has been intensity-modulated by the optical intensity modulation means by any of a plurality of detectors, and control means for controlling the intensity modulation of the quantum signal in the optical intensity modulation means in such a way that the quantum signal is incident on the plurality of detectors in a period in which variation in detection efficiency of the quantum signal in the plurality of detectors falls within a predetermined range.

A method for receiving a quantum signal according to an example aspect of the present disclosure includes intensity-modulating a quantum signal in such a way that the quantum signal is incident on a plurality of detectors in a period in which variation in detection efficiency of the quantum signal in the plurality of detectors falls within a predetermined range, the plurality of detectors detecting a photon of the quantum signal, and detecting the quantum signal that has been intensity-modulated, by any of the plurality of detectors.

According to the present disclosure, an eavesdropping attack on quantum key distribution can be prevented.

### BRIEF DESCRIPTION OF THE DRAWINGS

FIG. 1 is a block diagram illustrating a schematic configuration of a quantum key distribution system according to an example embodiment;

FIG. 2 is a diagram illustrating corresponding relationships between encoding bases and bits;

FIG. 3 is a block diagram schematically illustrating a configuration of a reception apparatus according to an example embodiment;

FIG. 4 is a block diagram schematically illustrating a main part configuration of the reception apparatus according to an example embodiment;

FIG. 5 is a diagram illustrating the main part configuration of the reception apparatus according to an example embodiment in more detail;

FIG. 6 is a diagram illustrating an example of a time window in a case where there is variation in time response between two single-photon detectors;

FIG. 7 is a block diagram schematically illustrating a configuration of a reception apparatus according to an example embodiment;

FIG. 8 is a diagram schematically illustrating a main part configuration of the reception apparatus according to an example embodiment;

FIG. 9 is a diagram illustrating reception of a quantum signal in the reception apparatus according to an example embodiment;

FIG. 10 is a diagram illustrating an example of a time window in a case where there is variation in time response between two single-photon detectors;

FIG. 11 is a diagram illustrating a difference between timings of time windows by two optical intensity modulators;

FIG. 12 is a diagram illustrating setting of a time window in the reception apparatus according to an example embodiment;

FIG. 13 is a diagram illustrating signal transmission in the reception apparatus according to an example embodiment;

FIG. 14 is a flowchart illustrating a detection procedure of a time shift attack in the reception apparatus according to an example embodiment;

FIG. 15 is a diagram schematically illustrating a configuration of the reception apparatus according to an example embodiment;

FIG. 16 is a diagram illustrating reception of a light pulse in the reception apparatus according to an example embodiment;

FIG. 17 is a diagram illustrating relationships between variations in time response of a single-photon detector and time windows in the reception apparatus according to an example embodiment;

FIG. 18 is a diagram schematically illustrating a time window set for four single-photon detectors in an example embodiment;

FIG. 19 is a diagram schematically illustrating a timing at which a voltage is applied to an APD and a degree of dependence of photon detection efficiency on time; and

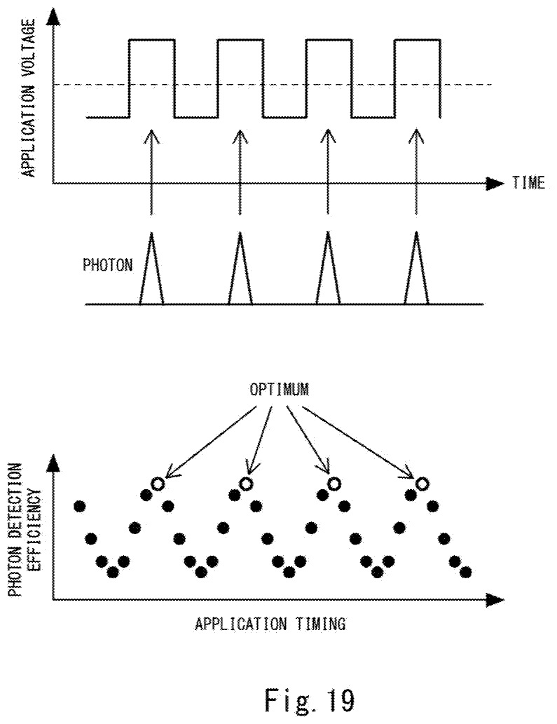

FIG. 20 is a diagram illustrating examples of degrees of dependence of photon detection efficiency on incident timing in a plurality of photon detectors.

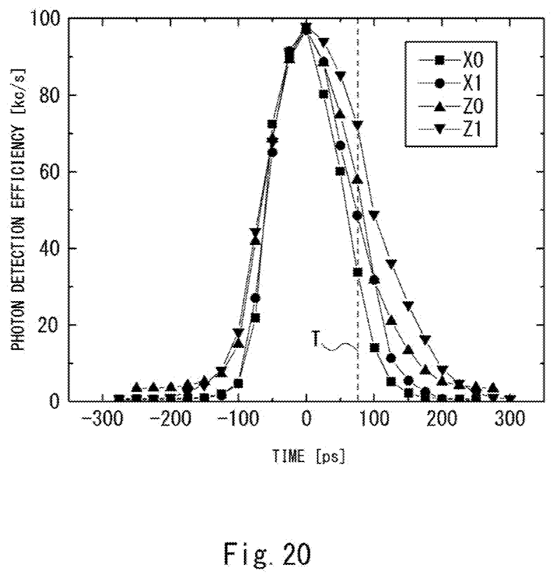

### EXAMPLE EMBODIMENT

Hereinafter, example embodiments of the present invention will be described with reference to the drawings. In each drawing, the same elements are denoted by the same reference signs, and redundant description is omitted as necessary.

The reference signs in the drawings used below are merely given to each element for convenience as an example for assisting understanding, and the configuration according to the following example embodiment is not limited to the illustrated mode. Connection lines between blocks in the drawings and the like referred to in the following description include both bidirectional and unidirectional connection lines. A unidirectional arrow schematically indicates a flow of a main signal or data, and does not exclude bidirectionality. Although a port or an interface may be interposed at an input/output connection point of each block in the drawing, illustration thereof is omitted.

Hereinafter, the term “one example embodiment” means that it is applicable to any of the example embodiments described below or to a combination of equal to or more than two example embodiments, and that the application is not limited to a specific example embodiment.

### First Example Embodiment

A first example embodiment that is an example of the example embodiments will be described in detail with reference to the drawings. The first example embodiment is a basic form of the example embodiments to be described below. An application range of each technique adopted in the first example embodiment is not limited to the first example embodiment. That is, each technique adopted in the first example embodiment may also be adopted in other example embodiments included in the present disclosure as long as no particular technical problem is raised. Each technique illustrated in the drawings referred to for describing the first example embodiment may also be adopted in other example embodiments included in the present disclosure as long as no particular technical problem is raised.

A quantum key distribution system 1000 according to a first example embodiment will be described. For example, the quantum key distribution system 1000 is configured as one to which a BB84 protocol in a phase encoding type or in a polarization encoding type is applied.

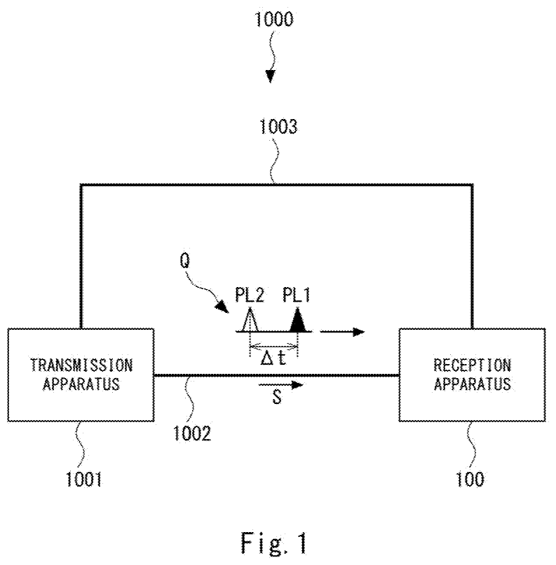

FIG. 1 is a block diagram illustrating a schematic configuration of a quantum key distribution system according to an example embodiment. As illustrated in FIG. 1, the quantum key distribution system 1000 includes a reception apparatus 100, a transmission apparatus 1001, and transmission paths 1002 and 1003. The transmission apparatus 1001 outputs a quantum signal Q used for giving an encryption key to the reception apparatus 100 and a synchronization signal S used for controlling a timing at which the quantum signal Q is detected to the reception apparatus 100 via the transmission path 1002. Furthermore, the transmission apparatus 1001 and the reception apparatus 100 can transmit and receive signals including, for example, base information, test bits, error correction information, and the like via the transmission path 1003 that is a public communication path.

The quantum signal Q is an optical signal transmitted as a light pulse including a single photon or a number of photons sufficient to exhibit a quantum effect.

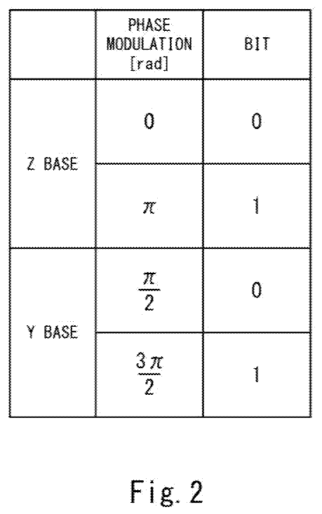

In the present example embodiment, the quantum signal Q output from the transmission apparatus 1001 is two continuous light pulses including a preceding pulse PL1 and a following pulse PL2. The transmission apparatus 1001 randomly selects one of the two encoding bases, and modulates the phase of the preceding pulse PL1 using the selected encoding base. FIG. 2 is a diagram illustrating corresponding relationships between encoding bases and bits. In the first encoding base (e.g., Z base), in a case where the phase shift of the preceding pulse PL1 is 0, the corresponding bit is “0”, and in a case where the phase shift of the preceding pulse PL1 is π, the corresponding bit is “1”. In the second encoding base (e.g., Y base), in a case where the phase shift of the preceding pulse PL1 is π/2, the corresponding bit is “0”, and in a case where the phase shift of the preceding pulse PL1 is 3π/2, the corresponding bit is “1”.

The transmission apparatus 1001 demultiplexes the light from the light source into the preceding pulse PL1 and the following pulse PL2. In a case where the first encoding base (e.g., Z base) is selected, the transmission apparatus 1001 shifts the phase of the preceding pulse PL1 by 0 or by π to encode the preceding pulse PL1. In a case where the second encoding base (e.g., Y base) is selected, the transmission apparatus 1001 shifts the phase of the preceding pulse PL1 by π/2 or by 3π/2 to encode the preceding pulse PL1. Thereafter, the transmission apparatus 1001 outputs, as the quantum signal Q, two continuous light pulses obtained by multiplexing the phase-modulated preceding pulse PL1 and the following pulse PL2 delayed from the preceding pulse PL1 by a predetermined amount Δt.

The synchronization signal S is an optical signal transmitted through the transmission path 1002 used for transmitting the quantum signal Q. The quantum signal Q and the synchronization signal S are, for example, optical signals having different wavelengths, and may be transmitted to the reception apparatus 100 after being wavelength-multiplexed.

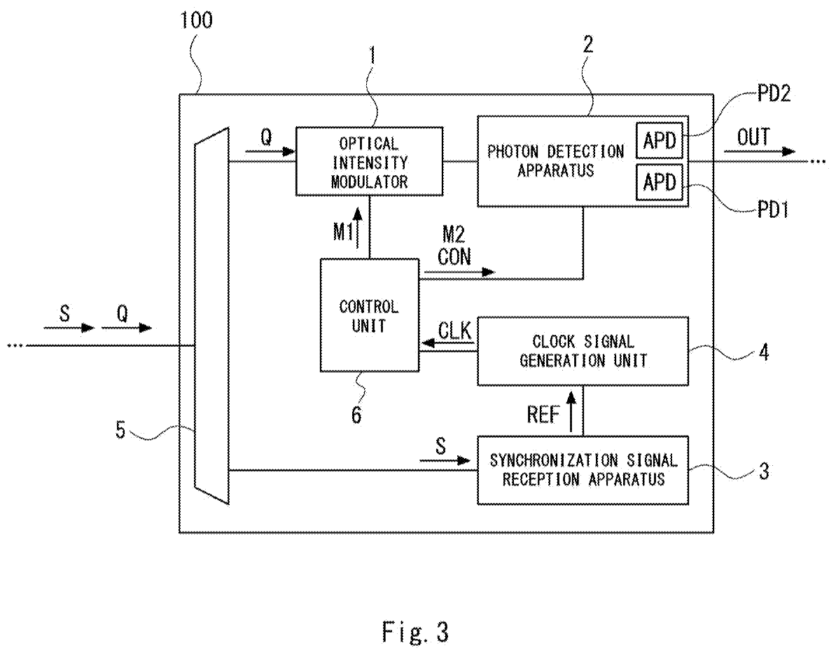

Next, the reception apparatus 100 will be described. FIG. 3 is a block diagram schematically illustrating a configuration of the reception apparatus according to an example embodiment. The reception apparatus 100 includes an optical intensity modulator 1, a photon detection apparatus 2, a synchronization signal reception apparatus 3, a clock signal generation unit 4, a wavelength separation unit 5, and a control unit 6.

The wavelength separation unit 5 wavelength-separates the quantum signal Q and the synchronization signal S. The wavelength separation unit 5 can include any wavelength separation means such as a WDM coupler. The wavelength separation unit 5 outputs the quantum signal Q to the optical intensity modulator 1. The wavelength separation unit 5 outputs the synchronization signal S to the synchronization signal reception apparatus 3.

The synchronization signal reception apparatus 3 outputs a reference signal REF indicating a timing at which the received synchronization signal S is received to the clock signal generation unit 4.

The clock signal generation unit 4 is configured as, for example, a phase locked loop (PLL). The clock signal generation unit 4 adjusts the timing of the clock signal CLK according to a reference signal REF indicating a timing at which the synchronization signal S is received. Then, the clock signal generation unit 4 outputs the clock signal CLK whose timing has been adjusted to the control unit 6.

The control unit 6 outputs a modulation signal M1 for controlling the operation of the optical intensity modulator 1, and a modulation signal M2 and a control signal CON for controlling the operation of the photon detection apparatus 2 according to the clock signal CLK received from the clock signal generation unit 4. Although not illustrated, the control unit 6 may control the timing of applying a bias to the single-photon detector included in the photon detection apparatus 2 according to the clock signal CLK.

The quantum signal Q is incident on the optical intensity modulator 1 from the wavelength separation unit 5. The optical intensity modulator 1 intensity-modulates the quantum signal Q incident on the time window W having a time width ΔT_{W} according to the modulation signal M1 from the control unit 6. As the optical intensity modulator 1, an electro-optic modulator such as a Mach-Zehnder modulator, an optical element and an optical instrument capable of various optical intensity modulations such as a light attenuator and an acousto-optic modulation may be used.

The photon detection apparatus 2 detects photons of the quantum signal Q from the optical intensity modulator 1 according to the modulation signal M2 and the control signal CON from the control unit 6. Then, the photon detection apparatus 2 outputs an output signal OUT indicating bits of the quantum signal Q according to the detection result of photons of the quantum signal Q.

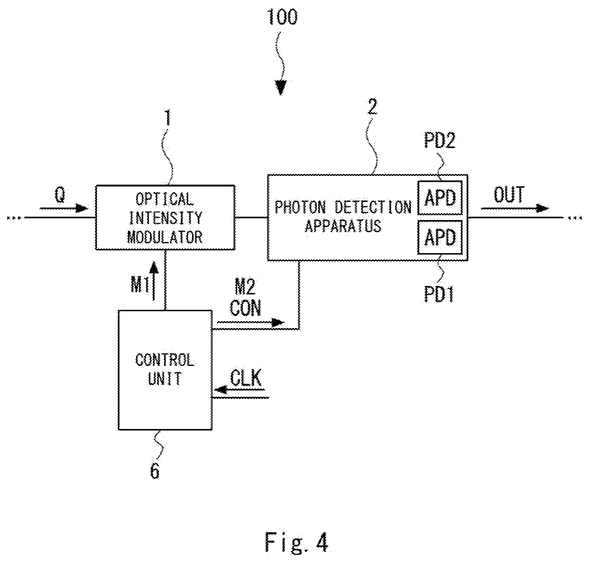

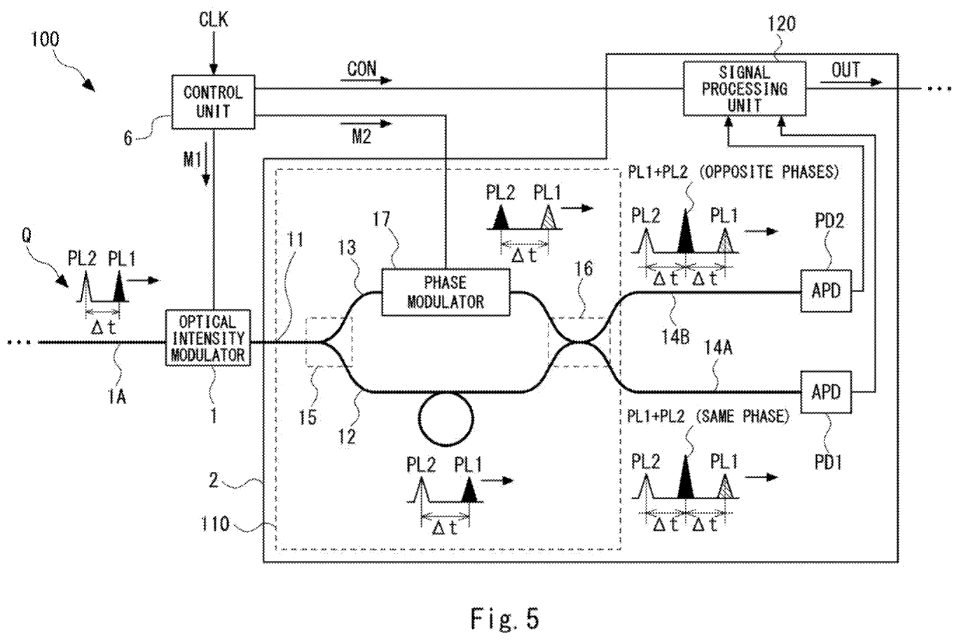

The reception of the quantum signal Q in the reception apparatus 100 will be described in more detail. FIG. 4 is a block diagram schematically illustrating a main part configuration of the reception apparatus according to an example embodiment. FIG. 5 is a diagram illustrating the main part configuration of the reception apparatus according to an example embodiment in more detail. As illustrated in FIG. 5, the optical intensity modulator 1 is inserted into an optical waveguide 1A connecting the wavelength separation unit 5 and the photon detection apparatus 2. As a result, the quantum signal Q including the two continuous light pulses output from the transmission apparatus 1001 is incident on the optical intensity modulator 1 via the optical waveguide 1A.

The optical intensity modulator 1 intensity-modulates the quantum signal Q according to the modulation signal M1 from the control unit 6 to pass only the quantum signal Q incident on the time window W having the time width ΔT_{W}. That is, the optical intensity modulator 1 blocks the incidence of the quantum signal Q on the photon detection apparatus 2 in the period other than the time window W by quenching the quantum signal Q incident in the period other than the time window W.

The photon detection apparatus 2 includes an interferometer 110, the signal processing unit 20, and two single-photon detectors PD1 and PD2 (also referred to as first and second detectors). Hereinafter, an avalanche photodiode (APD) is used as the single-photon detector.

The interferometer 110 includes a decoding unit including an asymmetric Mach-Zehnder interferometer that decodes a quantum signal Q. The interferometer 110 includes optical waveguides 12 and 13, a demultiplexer 15, a multiplexer/demultiplexer 16, and a phase modulator 17. The input 11 of the interferometer 110 is connected to the output of the optical intensity modulator 1 by the optical waveguide 1A. An input of the demultiplexer 15 is connected to the optical waveguide 1A via an input 11. One of two outputs of the demultiplexer 15 and one of two inputs of the multiplexer/demultiplexer 16 are connected to each other by the optical waveguide 12 (also referred to as a first path). The other of two outputs of the demultiplexer 15 and the other of two inputs of the multiplexer/demultiplexer 16 are connected to each other by the optical waveguide 13 (also referred to as a second path). One output of the multiplexer/demultiplexer 16 is connected to the single-photon detector PD1 by the optical waveguide 14A. The other output of the multiplexer/demultiplexer 16 is connected to the single-photon detector PD2 by the optical waveguide 14B. The optical waveguide 12 includes a waveguide having a longer optical path length than the optical waveguide 13.

The phase modulator 17 is inserted into the optical waveguide 13. For example, a general LN modulator or the like may be used as the phase modulator 17, but the phase modulator 17 is not limited thereto. The phase modulator 17 phase-modulates the quantum signal Q demultiplexed by the demultiplexer 15 and propagated through the optical waveguide 13 according to the modulation signal M2 from the control unit 6.

Each of the single-photon detectors PD1 and PD2 outputs a detection signal indicating a detection result of the decoded quantum signal Q (three continuous light pulses described later) to the signal processing unit 20.

The signal processing unit 20 detects the bit indicated by the quantum signal Q based on the detection signal from the single-photon detector PD1 or PD2 under the condition and at the timing designated by the control signal CON from the control unit 6. Then, the signal processing unit 20 outputs an output signal OUT indicating the detected bit.

Next, decoding of the quantum signal in the reception apparatus 100 will be described. The two continuous light pulses included in the quantum signal Q incident on the interferometer 110 are demultiplexed by the demultiplexer 15 into two continuous light pulses propagating through the optical waveguide 12 and two continuous light pulses propagating through the optical waveguide 13.

The optical waveguide 12 has an optical path length in which the light pulse propagating therethrough is delayed by Δt as compared with the light pulse propagating through the optical waveguide 13. As a result, the two continuous light pulses propagating through the optical waveguide 12 are delayed by Δt as compared with the two continuous light pulses propagating through the optical waveguide 13, at the time of being incident on the multiplexer/demultiplexer 16.

The phases of the two continuous light pulses propagating through the optical waveguide 13 are modulated by the phase modulator 17 according to the modulation signal M2. Whenever two continuous light pulses are input, the phase modulator 17 randomly selects one of the two encoding bases, and modulates the phase of the following pulse PL2 by 0 or by π/2 using the selected encoding base.

Specifically, in a case where the control unit 6 selects the first encoding base (e.g., Z base), the phase modulator 17 shifts the phase of the following pulse PL2 by 0 (that is, no modulation). In a case where the control unit 6 selects the second encoding base (e.g., Y base), the phase modulator 17 shifts the phase of the following pulse PL2 by π/2. The following pulse PL2 of which the phase has been modulated is incident on the multiplexer/demultiplexer 16 after propagating through the optical waveguide 13.

The two continuous light pulses having passed through the optical waveguide 12 and the two continuous light pulses having passed through the optical waveguide 13 are multiplexed by the multiplexer/demultiplexer 16 to form three continuous light pulses. The preceding pulse PL1 having passed through the optical waveguide 13 becomes a leading pulse of the three continuous light pulses, and the following pulse PL2 having passed through the optical waveguide 12 becomes a trailing pulse of the three continuous light pulses. The following pulse PL2 having been modulated in the phase modulator 17 and incident from the optical waveguide 13 and the preceding pulse PL1 incident from the optical waveguide 12 interfere with each other and form a central pulse between the leading pulse and the trailing pulse. Hereinafter, the preceding pulse PL1 after phase modulation by the phase modulator 17 is also referred to as a first light pulse. The following pulse PL2 is also referred to as a second light pulse.

Which one of the single-photon detectors PD1 and PD2 detects the photon of the central pulse depends on the phase shift by the phase modulator 17. That is, which one of the single-photon detectors PD1 and PD2 detects the photon of the central pulse depends on whether the following pulse PL2 having been modulated by the phase modulator 17 and the preceding pulse PL1 having passed through the optical waveguide 12 interfere with each other in the same phase or in opposite phases in the multiplexer/demultiplexer 16. In this configuration, in a case where interference occurs in the same phase, the central pulse propagates through the optical waveguide 14A, and photons are detected by the single-photon detector PD1. On the other hand, in a case where interference occurs in the opposite phase, the central pulse propagates through the optical waveguide 14B, and photons are detected by the single-photon detector PD2. In a case where the photon is detected by the single-photon detector PD1, the signal processing unit 20 acquires bit information “0” according to a detection signal of the single-photon detector PD1. In a case where the photon is detected by the single-photon detector PD2, the signal processing unit 20 acquires bit information “1” according to a detection signal of the single-photon detector PD2. In the present configuration, a quantum signal transmitted as two continuous light pulses as described above is decoded by the interferometer 110.

In a case where the phase shift in the transmission apparatus 1001 is 0 and the phase shift in the interferometer 110 is 0 (also referred to as a first combination), the phases are the same, and thus, a photon is detected by the single-photon detector PD1. In a case where the phase shift in the transmission apparatus 1001 is π and the phase shift in the interferometer 110 is 0 (also referred to as a second combination), the phases are opposite, and thus, a photon is detected by the single-photon detector PD2. These two cases are cases where the first encoding base (e.g., Z base) is selected in both the reception apparatus 100 and the transmission apparatus 1001.

In a case where the phase shift in the transmission apparatus 1001 is π/2 and the phase shift in the interferometer 110 is π/2 (also referred to as a third combination), the phases are the same, and thus, a photon is detected by the single-photon detector PD1. In a case where the phase shift in the transmission apparatus 1001 is 3π/2 and the phase shift in the interferometer 110 is π/2 (also referred to as a fourth combination), the phases are opposite, and thus, a photon is detected by the single-photon detector PD2. These two cases are cases where the second encoding base (e.g., Y base) is selected in both the reception apparatus 100 and the transmission apparatus 1001.

In a case where modulation is performed in a phase shift combination other than the above-described four phase shift combinations (that is, a case where the encoding bases selected by the transmission apparatus 1001 and the reception apparatus 100 are different from each other), a probability that a photon is detected by each of the single-photon detectors PD1 and PD2 is 50%. For example, in a case where the phase shift in the transmission apparatus 1001 is 0 and the phase shift in the interferometer 110 is π/2, the probability that the photon is detected by the single-photon detector PD1 is 50%, and a probability that a photon is detected by the single-photon detector PD2 is 50%. In this case, accurate reception cannot be performed, and accordingly, the received information is discarded and is not used for generating an encryption key.

As described above, in the photon detection apparatus, such as the photon detection apparatus 2, in which a plurality of single-photon detectors is provided, as described above, the single-photon detectors have individual differences in degree of dependence of photon detection sensitivity on incident timing. Such individual differences cause vulnerability to, for example, the above-described time shift attack.

On the other hand, in the reception apparatus 100, the optical intensity modulator 1 is provided in front of the photon detection apparatus 2. As a result, the quantum signal Q can be incident on the single-photon detectors PD1 and PD2 only at a preset timing. Therefore, by suitably performing the intensity modulation of the optical intensity modulator 1, the quantum signal Q can be made incident on the single-photon detectors PD1 and PD2 at a timing less affected by variations in the time response of the single-photon detectors PD1 and PD2.

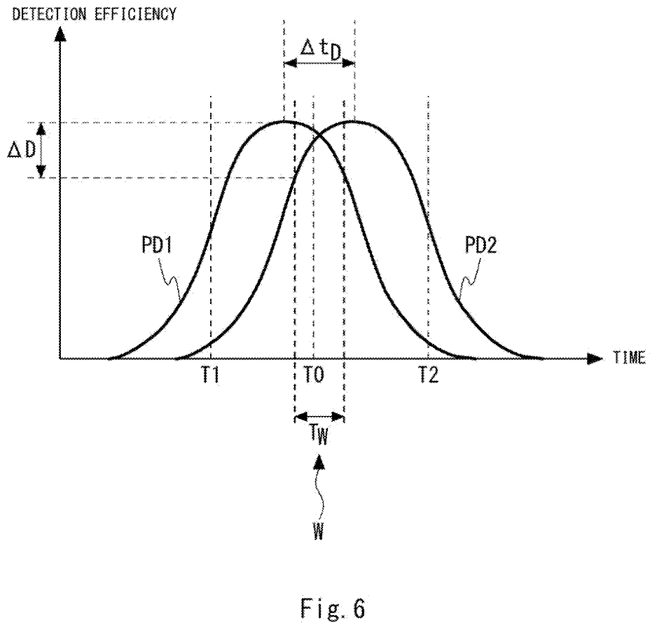

FIG. 6 is a diagram illustrating an example of a time window in a case where there is variation in time response between two single-photon detectors. In this example, the curves indicating the time responses of the single-photon detectors PD1 and PD2 have substantially the same shape. However, the time response of the single-photon detector PD1 has a peak earlier by Δt_{D} than the time response of the single-photon detector PD2. In this configuration, a period during which a difference in detection efficiency between the single-photon detectors PD1 and PD2 with respect to photons incident at the same timing becomes smaller than a predetermined value ΔD is set as the time window W of the width T_{W}.

Then, the control unit 6 controls the intensity modulation of the optical intensity modulator 1 in such a way that the quantum signal Q is incident on the single-photon detectors PD1 and PD2 at a timing included in the time window W, such as the timing T0.

For example, in a case where the quantum signal Q is incident at the timing T1, the detection efficiency in the single-photon detector PD2 is significantly lower than the detection efficiency in the single-photon detector PD1. Therefore, at the timing T1, even if the single-photon detector PD1 can detect the quantum signal Q, the single-photon detector PD2 may not detect the quantum signal Q. For example, in a case where the quantum signal Q is incident at the timing T2, the detection efficiency in the single-photon detector PD1 is significantly lower than the detection efficiency in the single-photon detector PD2. Therefore, at the timing T2, even if the single-photon detector PD2 can detect the quantum signal Q, the single-photon detector PD1 may not detect the quantum signal Q.

Therefore, the eavesdropper can observe the difference in response between the single-photon detectors PD1 and PD2 by intentionally shifting the incident timing of the quantum signal Q to the reception apparatus 100 to, for example, a timing at which the deviation in detection efficiency between the single-photon detectors PD1 and PD2 is large, such as the timings T1 and T2. As a result, the eavesdropper can control the detection result by the reception apparatus as desired.

On the other hand, in this configuration, the control unit 6 controls the intensity modulation of the optical intensity modulator 1 in such a way that the quantum signal Q is not incident on the single-photon detectors PD1 and PD2 at a timing included in the time window W, such as the timings T1 and T2.

As a result, the quantum signal Q is incident on the single-photon detectors PD1 and PD2 only at the timing included in the time window W having deviation of the detection efficiency smaller than the predetermined value. Therefore, the single-photon detectors PD1 and PD2 can detect the quantum signal Q incident at the timing included in the time window W with detection efficiency approximate to each other. Therefore, it is possible to prevent a difference in photon detection results due to a deviation in detection efficiency between the single-photon detectors PD1 and PD2. As a result, according to the reception apparatus 100, it is possible to suitably prevent a situation in which the detection result of photons is controlled by an eavesdropper.

This makes it possible to implement quantum key distribution with high confidentiality while preventing a time shift attack on quantum key distribution.

### Second Example Embodiment

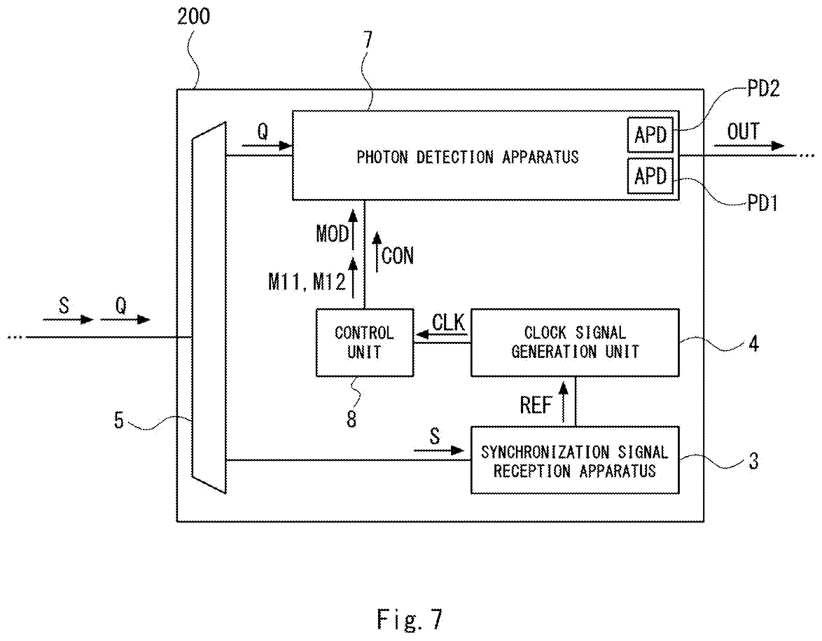

A reception apparatus according to the present example embodiment is different from the reception apparatus according to the first example embodiment in the arrangement of optical intensity modulators. FIG. 7 is a block diagram schematically illustrating a configuration of a reception apparatus according to an example embodiment. The reception apparatus 200 includes a photon detection apparatus 7, a synchronization signal reception apparatus 3, a clock signal generation unit 4, a wavelength separation unit 5, and a control unit 8. That is, the reception apparatus 200 has a configuration in which the optical intensity modulator 1 is removed and the photon detection apparatus 2 and the control unit 6 are replaced with the photon detection apparatus 7 and the control unit 8, respectively, as compared with the reception apparatus 100. The synchronization signal reception apparatus 3, the clock signal generation unit 4, and the wavelength separation unit 5 in the reception apparatus 200 are similar to those in the reception apparatus 100, and thus overlapping description is omitted.

The control unit 8 outputs a control signal CON and modulation signals MOD, M11, and M12 for controlling the operation of the photon detection apparatus 7 according to the clock signal CLK received from the clock signal generation unit 4. Although not illustrated, the control unit 8 may control the timing of applying a bias to the single-photon detector included in the photon detection apparatus 7 according to the clock signal CLK.

The photon detection apparatus 7 detects photons of the quantum signal Q according to the control signal CON and the modulation signals MOD, M11, and M12 from the control unit 8. Then, the photon detection apparatus 7 outputs an output signal OUT indicating bits of the quantum signal Q according to the detection result of photons of the quantum signal Q.

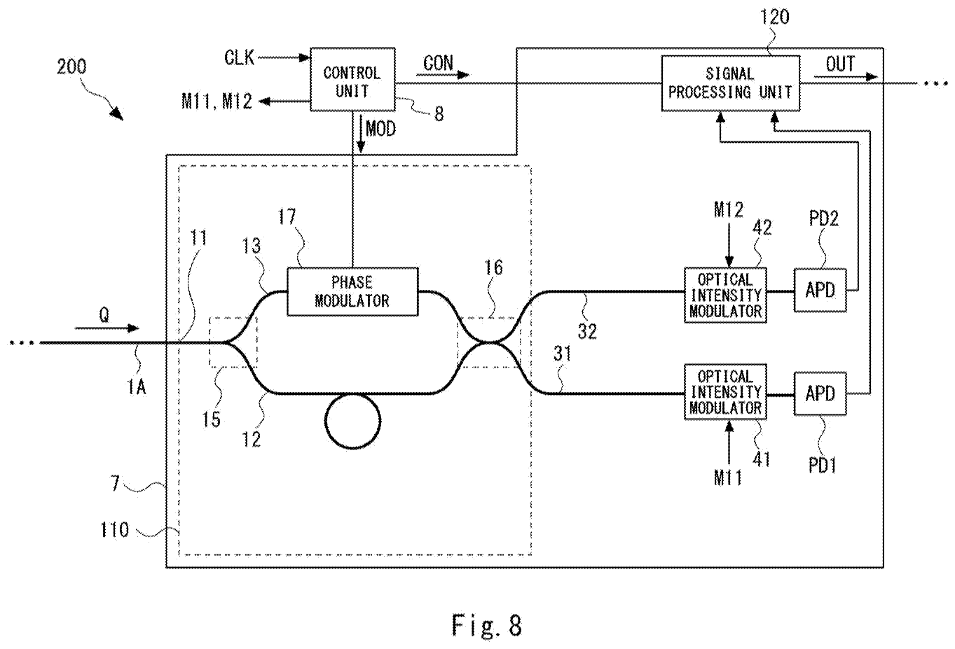

The reception of the quantum signal Q in the reception apparatus 200 will be described in more detail. FIG. 8 is a diagram schematically illustrating a main part configuration of the reception apparatus according to an example embodiment. The photon detection apparatus 7 includes an interferometer 110, a signal processing unit 120, single-photon detectors PD1, PD2, and optical intensity modulators 41, 42.

Since the configurations of the interferometer 110, the signal processing unit 120, and the single-photon detectors PD1 and PD2 in the photon detection apparatus 7 are similar to those in the photon detection apparatus 2, redundant description will be omitted.

In the photon detection apparatus 7, the phase modulator 17 of the interferometer 110 phase-modulates the light demultiplexed by the demultiplexer 15 and propagated through the optical waveguide 13 according to the modulation signal MOD from the control unit 8.

The optical intensity modulator 41 is inserted into the optical waveguide 31 between one of the two outputs of the multiplexer/demultiplexer 16 and the single-photon detector PD1. The optical intensity modulator 42 is inserted into the optical waveguide 32 between the other of the two outputs of the multiplexer/demultiplexer 16 and the single-photon detector PD2. As the optical intensity modulators 41 and 42, an electro-optic modulator such as a Mach-Zehnder modulator, an optical element and an optical instrument capable of various optical intensity modulations such as a light attenuator and an acousto-optic modulation may be used.

In response to the modulation signal M11 from the control unit 8, the optical intensity modulator 41 intensity-modulates the optical signal Q1 in such a way that the optical signal Q1 propagating through the optical waveguide 31 is incident on the single-photon detector PD1 at a timing belonging to the time window W of the time width ΔT_{W}. That is, the optical intensity modulator 41 passes only the interference light that can be incident on the single-photon detector PD1 at the timing belonging to the time window W. The optical intensity modulator 41 blocks the incidence of light on the single-photon detector PD1 in a period other than the time window W by quenching light that cannot be incident on the single-photon detector PD1 at a timing belonging to the time window W.

In response to the modulation signal M12 from the control unit 8, the optical intensity modulator 42 intensity-modulates the optical signal Q2 in such a way that the optical signal Q2 propagating through the optical waveguide 32 is incident on the single-photon detector PD2 at a timing belonging to the time window W of the time width ΔT_{W}. That is, the optical intensity modulator 42 passes only the light that can be incident on the single-photon detector PD2 at the timing belonging to the time window W. The optical intensity modulator 42 blocks the incidence of light on the single-photon detector PD2 in a period other than the time window W by quenching light that cannot be incident on the single-photon detector PD2 at a timing belonging to the time window W.

In the photon detection apparatus 7, the control unit 8 controls the intensity modulation in each of the optical intensity modulators 41 and 42 by the modulation signals M11 and M12 in such a way that the time window in which the optical signal Q1 is incident on the single-photon detector PD1 and the time window in which the optical signal Q2 is incident on the single-photon detector PD2 are synchronized as the same time window W.

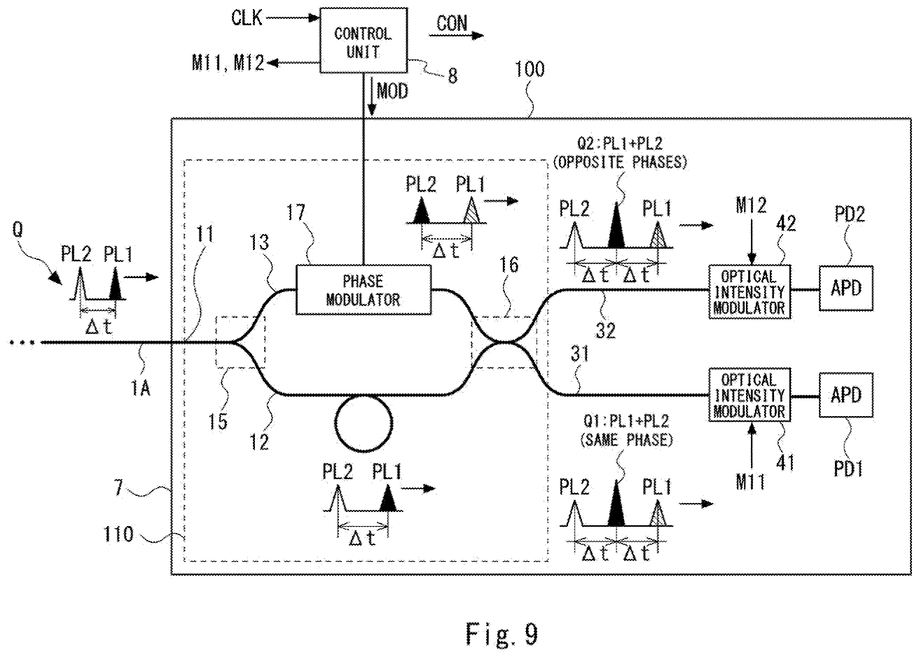

Next, reception of the quantum signal in the reception apparatus 200 will be described. FIG. 9 is a diagram illustrating reception of a quantum signal in the reception apparatus according to an example embodiment. As described in the above-described first example embodiment, the phases of the two continuous light pulses propagating through the optical waveguide 13 are modulated by the phase modulator 17. The control unit 8 controls the phase modulation in the phase modulator 17 by the modulation signal MOD in such a way as to randomly select one of the two encoding bases every time the two continuous light pulses are input. The phase modulator 17 modulates the phase of the following pulse PL2 by 0 or π/2 based on the selected encoding base.

Specifically, in a case where the control unit 8 selects the first encoding base (e.g., Z base), the phase modulator 17 shifts the phase of the following pulse PL2 by 0 (that is, no modulation). In a case where the control unit 8 selects the second encoding base (e.g., Y base), the phase modulator 17 shifts the phase of the following pulse PL2 by π/2. The following pulse PL2 of which the phase has been modulated is incident on the multiplexer/demultiplexer 16 after propagating through the optical waveguide 13. The two continuous light pulses incident from the optical waveguide 12 and the two continuous light pulses incident from the optical waveguide 13 interfere with each other by the multiplexer/demultiplexer 16, in such a way that three continuous light pulses are formed as in the case of first example embodiment.

Which one of the single-photon detectors PD1 and PD2 detects the photon of the central pulse depends on the phase shift by the phase modulator 17. That is, which one of the single-photon detectors PD1 and PD2 detects the photon of the central pulse depends on whether the following pulse PL2 having been phase-modulated by the phase modulator 17 and the preceding pulse PL1 incident from the optical waveguide 12 interfere with each other in the same phase or in opposite phases in the multiplexer/demultiplexer 16. In this configuration, in a case where interference occurs in the same phase, the central pulse propagates through the optical waveguide 31 toward the optical intensity modulator 41 and the single-photon detector PD1. The central pulse incident on the optical intensity modulator 41 through the optical waveguide 31 is the above-described optical signal Q1. By applying a gate pulse to the APD included in the single-photon detector PD1 in synchronization with the incident timing of the central pulse, the single-photon detector PD1 detects the central pulse corresponding to the optical signal Q1. On the other hand, in a case where interference occurs in opposite phases, the central pulse is propagated toward the optical intensity modulator 42 and the single-photon detector PD2 through the optical waveguide 32. The central pulse incident on the optical intensity modulator 42 through the optical waveguide 32 is the above-described optical signal Q2. By applying a gate pulse to the APD included in the single-photon detector PD2 in synchronization with the incident timing of the central pulse, the single-photon detector PD2 detects the central pulse corresponding to the optical signal Q2.

Accordingly, in the photon detection apparatus 7, similarly to the photon detection apparatus 2, in a case where the photon is detected by the single-photon detector PD1, the signal processing unit 120 acquires bit information “0”. In a case where the photon is detected by the single-photon detector PD2, the signal processing unit 120 acquires bit information “1”.

As described above, in the photon detection apparatus, such as the photon detection apparatus 7, in which a plurality of single-photon detectors is provided, as described above, the single-photon detectors have individual differences in degree of dependence of photon detection sensitivity on incident timing. Such individual differences cause vulnerability to, for example, the above-described time shift attack.

On the other hand, in the reception apparatus 200, the optical intensity modulator 41 is provided in the optical waveguide 31 connected to the single-photon detector PD1. In addition, the optical intensity modulator 42 is provided in the optical waveguide 32 connected to the single-photon detector PD2.

Therefore, by suitably executing the intensity modulation in the optical intensity modulators 41 and 42, the optical signals Q1 and Q2 can be made incident on the single-photon detectors PD1 and PD2, respectively, at a desired timing. As a result, the optical signals Q1 and Q2 from the multiplexer/demultiplexer 16 can be made incident on the single-photon detectors PD1 and PD2, respectively, at a timing less affected by variations in the time response of the single-photon detectors PD1 and PD2.

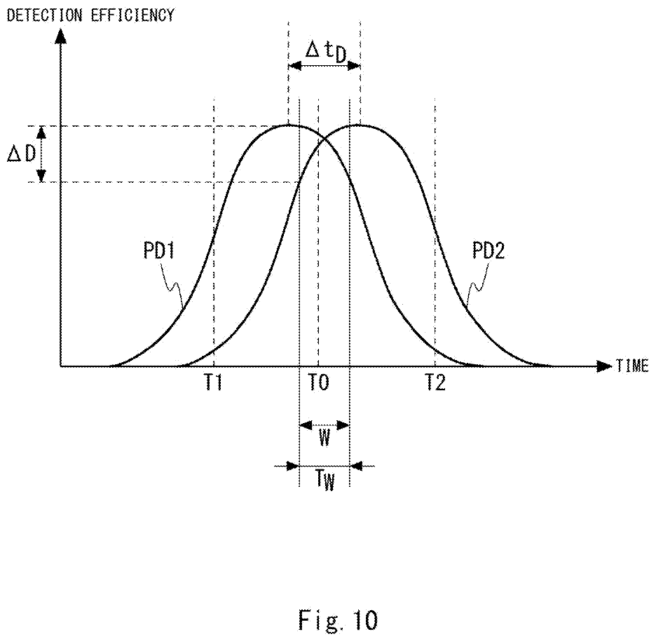

FIG. 10 is a diagram illustrating an example of a time window in a case where there is variation in time response between two single-photon detectors. In this example, the curves indicating the time responses of the single-photon detectors PD1 and PD2 have substantially the same shape. The time response of the single-photon detector PD1 has a peak earlier by Δt_{D} than the time response of the single-photon detector PD2.

In this case, near the peaks of the time responses of the single-photon detectors PD1 and PD2, there is a period in which the detection efficiency of the single-photon detectors PD1 and PD2 for photons incident at the same timing is close. Therefore, in this configuration, the intensity modulation in the optical intensity modulators 41 and 42 is controlled in such a way that the interference light is incident on the single-photon detectors PD1 and PD2 during the time window W having the width T_{W} in which the difference in the detection efficiency is smaller than the predetermined value ΔD near the peak of the detection efficiency of the single-photon detectors PD1 and PD2.

As a result, for example, if the interference light is incident on the single-photon detectors PD1 and PD2 at the timing T0 belonging to the time window W, the difference in detection efficiency between the single-photon detectors PD1 and PD2 can be suppressed to be smaller than ΔD.

For example, in a case where the interference light is incident at the timing T1 not belonging to the time window W, the detection efficiency in the single-photon detector PD2 is significantly lower than the detection efficiency in the single-photon detector PD1. Therefore, at the timing T1, even if the single-photon detector PD1 can detect the interference light, the single-photon detector PD2 may not detect the interference light. For example, in a case where the interference light is incident at the timing T2 not belonging to the time window W, the detection efficiency in the single-photon detector PD1 is significantly lower than the detection efficiency in the single-photon detector PD2. Therefore, at the timing T2, even if the single-photon detector PD2 can detect the interference light, the single-photon detector PD1 may not detect the interference light.

Therefore, the eavesdropper can observe the difference in response between the single-photon detectors PD1 and PD2 by intentionally shifting the incident timing of the quantum signal Q to the reception apparatus 200 in such a way that, for example, the deviation in detection efficiency of the interference light between the single-photon detectors PD1 and PD2 is large, such as the timings T1 and T2. As a result, the eavesdropper can control the detection result by the reception apparatus as desired.

On the other hand, in this configuration, the control unit 8 controls the intensity modulation of the optical intensity modulators 41 and 42 in such a way that the optical signals Q1 and Q2 are not incident on each of the single-photon detectors PD1 and PD2 at a timing not belonging to the time window W, such as the timings T1 and T2.

As a result, the optical signals Q1 and Q2 are incident on the single-photon detectors PD1 and PD2 only at the timing belonging to the time window W having deviation of the detection efficiency smaller than the predetermined value. Therefore, the single-photon detectors PD1 and PD2 can detect the optical signals Q1 and Q2 incident at the timing belonging to the time window W with detection efficiency approximate to each other.

Therefore, it is possible to prevent a difference in photon detection results due to a deviation in detection efficiency between the single-photon detectors PD1 and PD2. As a result, according to the reception apparatus 200, it is possible to suitably prevent a situation in which the detection result of photons is controlled by an eavesdropper.

### Third Example Embodiment

In the second example embodiment 2, the intensity modulation of the optical intensity modulators 41 and 42 is controlled in such a way that the incident timings of the optical signals Q1 and Q2 to the single-photon detectors PD1 and PD2 fall within the time window W. However, it is generally difficult to strictly match the timings of the intensity modulation of the optical intensity modulators 41 and 42.

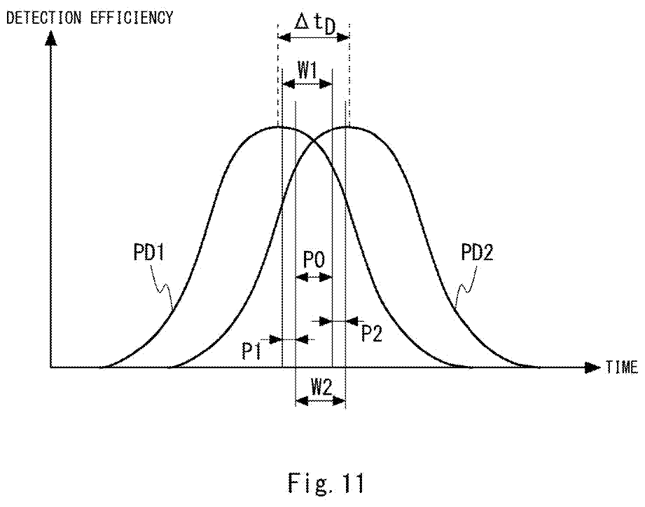

FIG. 11 is a diagram illustrating a difference between timings of time windows by two optical intensity modulators. Since the optical intensity modulator 41 and the optical intensity modulator 42 are physically separated from each other, it is difficult to strictly match the timings of the time windows through which the optical signals pass. Therefore, even if the time window W1 by the optical intensity modulator 41 and the time window W2 by the optical intensity modulator 42 have the same width, the time window W2 may be delayed with respect to the time window W1, for example, as illustrated in FIG. 11.

Here, a period in which only the time window W1 exists is P1, a period in which the time window W1 and the time window W2 overlap is P0, and a period in which only the time window W2 exists is P2.

In the period P1, the optical signal Q1 can be incident on the single-photon detector PD1, but the optical signal Q2 cannot be incident on the single-photon detector PD2. Therefore, the bit “0” corresponding to the interference light Q1 incident on the single-photon detector PD1 is detected with high probability. On the other hand, in the period P2, the optical signal Q1 cannot be incident on the single-photon detector PD1, but the optical signal Q2 can be incident on the single-photon detector PD2. Therefore, the bit “1” corresponding to the interference light Q2 incident on the single-photon detector PD2 is detected with high probability.

Therefore, in a case where the incident timing of the quantum signal Q to the reception apparatus is intentionally controlled by a time shift attack by a malicious third party, there is a possibility that the optical signal is incident only on one of the single-photon detectors PD1 and PD2, and the time shift attack becomes effective.

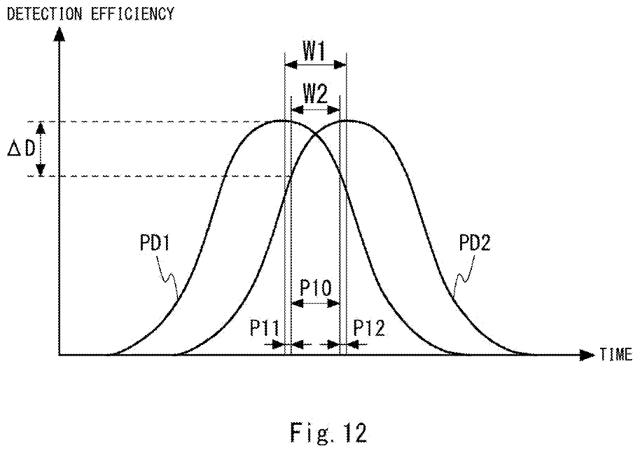

Therefore, in the present example embodiment, the setting of the time window capable of preventing the time shift attack in the above-described case will be described. FIG. 12 is a diagram illustrating setting of a time window in the reception apparatus according to an example embodiment. In the present example embodiment, the time window W1 by the single-photon detector PD1 is set to be longer than the time window W2 by the single-photon detector PD2 and to include the time window W2 by the single-photon detector PD2.

Here, in the time window W1, a period before the start period of the time window W2 is defined as P11. In the time window W1, a period after the end period of the time window W2 is defined as P12. A period in which the time window W1 and the time window W2 overlap is defined as P10.

In the period P11, the optical signal Q2 is not incident on the single-photon detector PD2 by being blocked by the optical intensity modulator 42. Therefore, in the period P11, the bit “0” corresponding to the optical signal Q1 incident on the single-photon detector PD1 is detected with high probability.

In the period P12, the optical signal Q2 is not incident on the single-photon detector PD2 by being blocked by the optical intensity modulator 42. Therefore, in the period P12, the bit “0” corresponding to the optical signal Q1 incident on the single-photon detector PD1 is detected with high probability.

Therefore, in the reception apparatus 200 according to the present example embodiment, detection of the bit “0” only increases even if the time shift attack is performed. As a result, in response to the detection rate of the bit “0” becoming high, it is possible to detect that the time shift attack is performed.

In the present example embodiment, it has been described that the time window W1 by the single-photon detector PD1 is set to include the time window W2 by the single-photon detector PD2, but the inclusion relationship of the time windows W1 and W2 is not limited thereto. The time window W1 by the single-photon detector PD1 may be set to be included in the time window W2 by the single-photon detector PD2. In this case, in response to the detection rate of the bit “1” becoming high, it can be detected that the time shift attack is performed.

In this case, since the detection rate of the detection bit is biased to “0” by the time shift attack, it is considered that the eavesdropping by the third party is partially successful. Therefore, the apparatus that receives the output signal OUT from the signal processing unit 120 may issue the alarm ALM in response to detecting that the time shift attack is performed. As a result, the user can stop the quantum key generation.

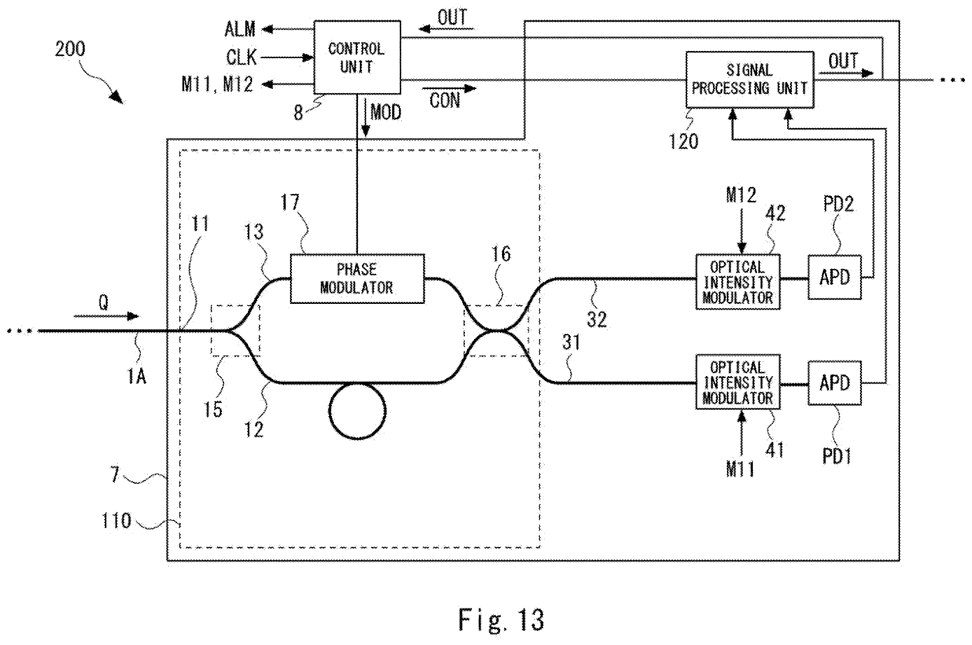

FIG. 13 is a diagram illustrating signal transmission in the reception apparatus according to an example embodiment. In the present example embodiment, the signal processing unit 120 may output the output signal OUT to the control unit 8. The control unit 8 may monitor the output signal OUT and issue an alarm ALM in a case where the detection rate of the detection bit “0” becomes significantly large.

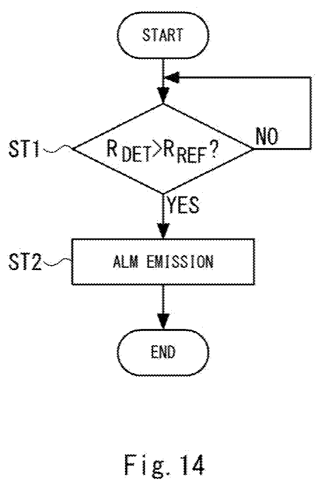

FIG. 14 is a flowchart illustrating a detection procedure of a time shift attack in the reception apparatus according to an example embodiment.

### Step ST1

The control unit 8 monitors whether the detection rate R_{DET} of the detection bit “0” is larger than the reference value R_{REF} based on the output signal OUT from the signal processing unit 120. If the detection rate R_{DET} of the detection bit “0” is smaller than the reference value R_{REF}, the control unit 8 continues monitoring.

### Step ST2

If the detection rate R_{DET} of the detection bit “0” is larger than the reference value R_{REF}, the control unit 8 issues an alarm ALM. As a result, the user of the reception apparatus 200 can detect that the time shift attack may be performed on the quantum signal Q transmitted to the reception apparatus 200. In response to this, the user can discard the reception result of the quantum signal Q or take measures to prevent eavesdropping.

In a case where the detection rate R_{DET} of the detection bit “0” matches the reference value R_{REF}, if necessary, the detection rate R_{DET} may be handled as in a case where the detection rate R_{DET} is larger than the reference value R_{REF}, or may be handled as in a case where the detection rate R_{DET} is smaller than the reference value R_{REF}.

As described above, according to the reception apparatus according to the present example embodiment, similarly to the case of the second example embodiment, it is possible to suitably prevent a situation in which detection results of photons in a plurality of single-photon detectors are controlled by an eavesdropper. Furthermore, with the reception apparatus according to the present example embodiment, it is also possible to detect that there is a possibility of a time shift attack being performed.

### Fourth Example Embodiment

In the above-described example embodiment, the reception apparatus that detects the bits of the two encoding bases by the two single-photon detectors PD1 and PD2 by selecting the encoding bases by phase modulation by the phase modulator 17 has been described. However, in a case where the bits of the two encoding bases in the BB84 protocol are detected, it is also possible to configure a reception apparatus that detects the bits of the two encoding bases by providing four single-photon detectors without using a phase modulator.

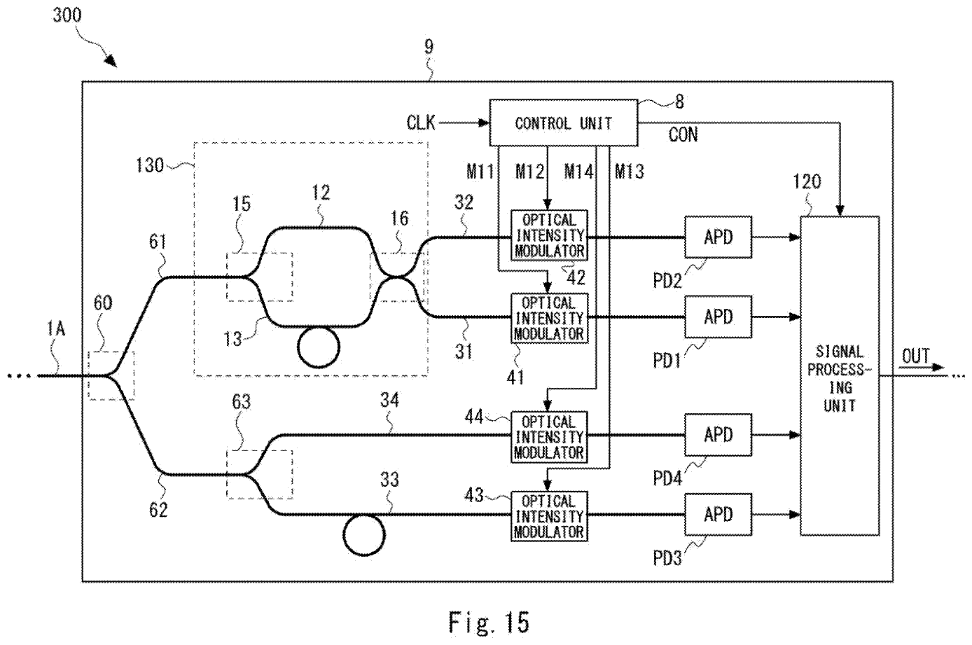

FIG. 15 is a diagram schematically illustrating a configuration of the reception apparatus according to an example embodiment. In the reception apparatus 300, the photon detection apparatus 7 of the reception apparatus 200 is replaced with a photon detection apparatus 9. In the photon detection apparatus 9, the interferometer 110 of the photon detection apparatus 7 is replaced with an interferometer 130. In the reception apparatus 300, the optical waveguides 33 and 34, the optical intensity modulators 43 and 44, the demultiplexer 60, the optical waveguides 61 and 62, the demultiplexer 63, and the single-photon detectors PD3 and PD4 are further provided. Hereinafter, the single-photon detectors PD3 and PD4 are also referred to as third and fourth detectors, respectively.

The demultiplexer 60 branches the quantum signal Q incident through the optical waveguide 1A. The one branched quantum signal Q propagates to the interferometer 130 through the optical waveguide 61. The other branched quantum signal Q is incident on the demultiplexer 63 through the optical waveguide 62.

The interferometer 130 has a configuration in which the phase modulator 17 is removed from the interferometer 110.

The demultiplexer 63 branches the quantum signal Q incident through the optical waveguide 62. The one branched quantum signal Q is propagated toward the optical intensity modulator 43 and the single-photon detector PD3 through the optical waveguide 33. The other branched quantum signal Q is propagated toward the optical intensity modulator 44 and the single-photon detector PD4 through the optical waveguide 34. In this configuration, the optical waveguide 33 has an optical path length longer than that of the optical waveguide 34 in such a way that the quantum signal Q incident on the single-photon detector PD3 is delayed by a time difference Δt between the preceding pulse PL1 and the following pulse PL2 relative to the quantum signal Q incident on the single-photon detector PD4.

Next, transmission of the quantum signal Q in the present example embodiment will be described. In the present example embodiment, in the transmission apparatus 1001, two continuous light pulses including a preceding pulse PL1 and a following pulse PL2 are demultiplexed into two. The demultiplexed one of the two continuous light pulses is subjected to a phase shift of 0 or π/2(φ1={0, π/2}) by a phase modulator provided in the transmission apparatus 1001. The demultiplexed other of the two continuous light pulses is subjected to a phase shift of 0 or π(φ2={0, π}) by the phase modulator provided in the transmission apparatus 1001. Then, the quantum signal Q is transmitted by multiplexing the two continuous light pulses after the phase shift. As a result, four non-orthogonal states required by the BB84 protocol are generated.

In the first state, a phase modulation of {φ1,φ2}={0,0} is performed on the preceding pulse PL1 and a phase modulation of {φ1,φ2}={0,π} is performed on the following pulse PL2. In this case, if the two continuous light pulses after the phase shift are multiplexed, only a preceding pulse PL1 having an intensity of 1 is present.

In the second state, the same phase modulations as those in the first state are performed but in the reverse order, that is, a phase modulation of {φ1,φ2}={0,π} is performed on the preceding pulse PL1, and a phase modulation of {φ1,φ2}={0,0} is performed on the following pulse PL2. In this case, if the two continuous light pulses after the phase shift are multiplexed, only a following pulse PL2 having an intensity of 1 is present.

Here, the first and second states are defined as “two states belonging to the Z base”, and a bit “0” is assigned to the first state and a bit “1” is assigned to the second state. Since the first and second states are orthogonal states, the first and second states can be easily distinguished from each other by measurement.

In third state, a phase modulation of {φ1,φ2}={π/2,0} is performed on the preceding pulse PL1 of the two continuous light pulses, and a phase modulation of {φ1,φ2}={π/2,π} is performed on the following pulse PL2 of the two continuous light pulses. In this case, if the two continuous light pulses output from the phase modulators 4A and 4B are multiplexed, two continuous light pulses including a preceding pulse PL1 having an intensity of ½ and a phase of π/4 and a following pulse PL2 having an intensity of ½ and a phase of −π/4 are present.

In the fourth state, the same phase modulations as those in the third state are performed but in the reverse order, that is, a phase modulation of {φ1,φ2}={π/2,π} is performed on the preceding pulse PL1 of the two continuous light pulses, and a phase modulation of {φ1,φ2}={π/2,0} is performed on the following pulse PL2. In this case, if the two continuous light pulses output from the phase modulators 4A and 4B are multiplexed, two continuous light pulses including a preceding pulse PL1 having an intensity of ½ and a phase of −π/4 and a following pulse PL2 having an intensity of ½ and a phase of π/4 are present.

Here, the third and fourth states are defined as “two states belonging to the Y base”, and a bit “0” is assigned to the third state and a bit “1” is assigned to the fourth state. Since the third and fourth states are orthogonal states, the third and fourth states can be easily distinguished from each other by measurement.

Note that, since a state belonging to the Z base and a state belonging to the Y base are not orthogonal to each other, it is not possible to accurately distinguish them from each other by any measurement. As a result, four non-orthogonal states required by the BB84 protocol are generated.

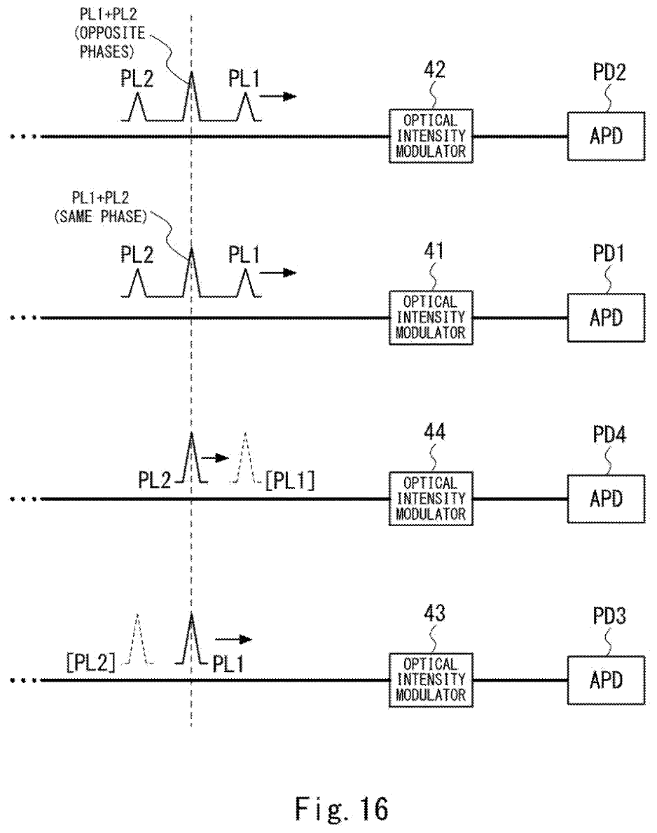

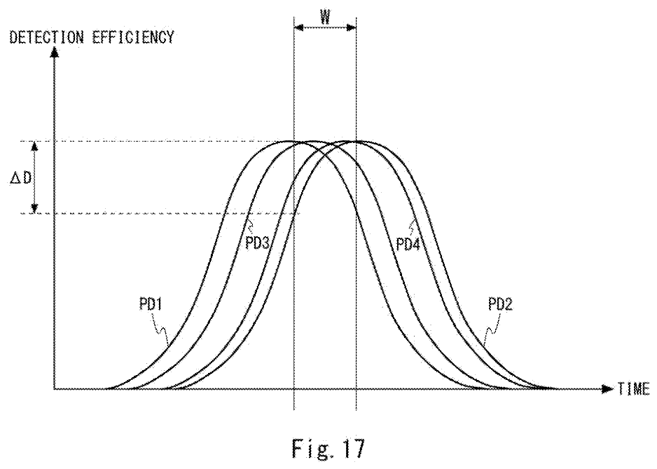

Next, the operations of the reception apparatus 300 will be described. FIG. 16 is a diagram illustrating reception of a light pulse in the reception apparatus according to an example embodiment. FIG. 17 is a diagram illustrating relationships between variations in time response of a single-photon detector and time windows in the reception apparatus according to an example embodiment.

In photon detection related to the Z base, a central pulse (photon) is guided to the single-photon detector PD1 in the first state (bit 0), and a central pulse (photon) is guided to the single-photon detector PD2 in the second state (bit 1). This corresponds to a case where the phase modulation by the phase modulator 17 is 0 in the interferometer 110 according to the second example embodiment.

Photon detection according to the Y base is performed on the basis of the quantum signal Q branched toward the single-photon detector PD3 and the single-photon detector PD4. As described above, the optical path length of the optical waveguide 33 is longer than that of the optical waveguide 34 by Δt. In the present example embodiment, a time window W temporally synchronized by the optical intensity modulators 43 and 44 is set for the single-photon detectors PD3 and PD4 accordingly. As a result, it is possible to synchronize the timing at which the preceding pulse PL1 in the third state (bit 0) is incident on the single-photon detector PD3 with the timing at which the following pulse PL2 in the fourth state (bit 1) is incident on the single-photon detector PD4.

A gate pulse is applied to the APD included in the single-photon detector PD3 in synchronization with the incident timing of the preceding pulse PL1 in the third state (bit 0). The time window W is provided in synchronization with the incident timing of the preceding pulse PL1. As a result, the single-photon detector PD3 detects the preceding pulse PL1 of the third state (bit 0) that has passed through the time window W. On the other hand, at the incident timing of the following pulse PL2 in the fourth state (bit 1), the gate pulse is not applied to the APD included in the single-photon detector PD3. Therefore, the single-photon detector PD3 can selectively detect only the preceding pulse PL1 in the third state (bit 0).

A gate pulse is applied to the APD included in the single-photon detector PD4 in synchronization with the incident timing of the following pulse PL2 in the fourth state (bit 1). The time window W is provided in synchronization with the incident timing of the following pulse PL2. As a result, the single-photon detector PD4 detects the following pulse PL2 of the fourth state (bit 1) that has passed through the time window W. On the other hand, at the incident timing of the preceding pulse PL1 in the third state (bit 0), the gate pulse is not applied to the APD included in the single-photon detector PD4. Therefore, the single-photon detector PD4 can selectively detect only the following pulse PL2 in the fourth state (bit 1).

In the present configuration, the control unit 8 controls the intensity modulation in the optical intensity modulators 41 to 44 by the modulation signals M11 to M14 in such a way as to provide the time window W in time synchronization with the single-photon detectors PD1 to PD4. As a result, even in a case where the responses of the single-photon detectors PD1 to PD4 vary, the time shift attack can be suitably prevented as in the case of the second example embodiment.

As in the case of the third example embodiment, even if time windows having the same width are provided for the single-photon detectors PD1 to PD4, it is assumed that there is a case where it is difficult to strictly synchronize the time windows W1 to W4 of the single-photon detectors PD1 to PD4.

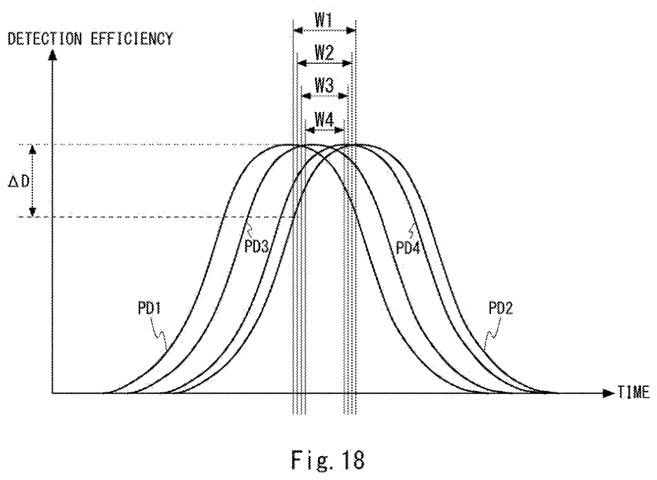

In this case, as in the case of the second example embodiment, the control unit 8 may gradually narrow the widths of the time windows W1 to W4 set for the single-photon detectors PD1 to PD4. FIG. 18 is a diagram schematically illustrating time windows set for four single-photon detectors in an example embodiment; The control unit 8 controls the intensity modulation in the optical intensity modulators 41 to 44 in such a way that the widths of the time windows W1 to W4 set for the single-photon detectors PD1 to PD4 are gradually narrowed and have a hierarchical relationship. As illustrated in FIG. 18, the control unit 8 may set the time windows W1 to W4 in such a way that

W1⊂W2⊂W3⊂W4

is satisfied.

This is merely an example, and the inclusion relationship in the time windows W1 to W4 may be set as desired. Each of the time windows W1 to W4 may be arranged in any order as long as the time windows W1 to W4 are arranged hierarchically or nested.

That is, the inclusion relationship in the time windows W1 to W4 may be any of the following.
(1) W1⊂W2⊂W3⊂W4
(2) W1⊂W2⊂W4⊂W3
(3) W1⊂W3⊂W2⊂W4
(4) W1⊂W3⊂W4⊂W2
(5) W1⊂W4⊂W2⊂W3
(6) W1⊂W4⊂W3⊂W2
(7) W2⊂W1⊂W3⊂W4
(8) W2⊂W1⊂W4⊂W3
(9) W2⊂W3⊂W1⊂W4
(10) W2⊂W3⊂W4⊂W1
(11) W2⊂W4⊂W1⊂W3
(12) W2⊂W4⊂W3⊂W1
(13) W3⊂W1⊂W2⊂W4
(14) W3⊂W1⊂W4⊂W2
(15) W3⊂W2⊂W1⊂W4
(16) W3⊂W2⊂W4⊂W1
(17) W3⊂W4⊂W1⊂W2
(18) W3⊂W4⊂W2⊂W1
(19) W4⊂W1⊂W2⊂W3
(20) W4⊂W1⊂W3⊂W2
(21) W4⊂W2⊂W1⊂W3
(22) W4⊂W2⊂W3⊂W1
(23) W4⊂W3⊂W1⊂W2
(24) W4⊂W3⊂W2⊂W1

Therefore, according to the reception apparatus 300 according to the present example embodiment, even in a case where photons are detected by four single-photon detectors, a time shift attack can be suitably avoided.

### Other Example Embodiments

While the present disclosure has been particularly shown and described with reference to example embodiments thereof, the present disclosure is not limited to these example embodiments. Various changes that can be understood by those of ordinary skill in the art can be made to the configurations and details of the present disclosure within the scope of the present disclosure. And each example embodiment can be appropriately combined with other embodiments.

The configuration for implementing the BB84 protocol in the phase encoding type and the configuration for implementing the BB84 protocol in the polarization encoding type in the above-described example embodiments are merely examples, and it goes without saying that other configurations can be taken as appropriate as long as similar quantum key distribution can be implemented.

In the above-described example embodiment, it has been described that an avalanche photodiode is used as the single-photon detector, but this is merely an example. A single-photon detector having another configuration may be applied as long as it is a single-photon detector whose photon detection efficiency depends on the photon incidence timing.

The configuration of the photon detection apparatus described in the above example embodiment is merely an example. A photon detection apparatus having another configuration may be used as long as it can detect photons of a quantum signal by using a plurality of single-photon detectors.

Each of the drawings is merely illustrative for describing one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing exemplary example embodiments are not necessarily mandatory, and some features or steps may be omitted. The order of the steps described in any of the drawings may be appropriately changed.

Some or all of the above example embodiments can also be described as the following Supplementary Notes, but are not limited to the following.

### (Supplementary Note 1)

A reception apparatus including:
optical intensity modulation means for intensity-modulating an incident quantum signal;
photon detection means for detecting photons of the quantum signal that has been intensity-modulated by the optical intensity modulation means by any of a plurality of detectors; and
control means for controlling the intensity modulation of the quantum signal in the optical intensity modulation means in such a way that the quantum signal is incident on the plurality of detectors in a period in which variation in detection efficiency of the quantum signal in the plurality of detectors falls within a predetermined range.

### (Supplementary Note 2)

The reception apparatus according to supplementary note 1, in which
the quantum signal that has been intensity-modulated by the optical intensity modulation means is incident on the photon detection means, and
the optical intensity modulation means
causes a quantum signal incident at a timing included in the period in which variation in detection efficiency of the quantum signal in the plurality of detectors falls within the predetermined range to pass to the photon detection means, and
blocks a quantum signal incident at a timing not included in the period in which variation in detection efficiency of the quantum signal in the plurality of detectors falls within the predetermined range.

### (Supplementary Note 3)

The reception apparatus according to supplementary note 2, in which the photon detection means includes:
decoding means for decoding the quantum signal received from the optical intensity modulation means;
the plurality of detectors for detecting photons of the quantum signal that has been decoded by the decoding means; and
signal processing means for detecting a bit of the quantum signal that has been decoded, based on detection results of photons by the plurality of detectors.

### (Supplementary Note 4)

The reception apparatus according to supplementary note 3, in which
a phase of a light pulse included in the quantum signal incident on the optical intensity modulation means is shifted by 0 or π in a first encoding base, and is shifted by π/2 or 3π/2 in a second encoding base, and
the decoding means is an interferometer that allows a quantum signal to be incident thereon, the quantum signal including a first light pulse of which a phase has been modulated in advance and a second light pulse delayed from the first light pulse by a predetermined time, delays the first light pulse by the predetermined time and modulates a phase of the second light pulse, causes the first light pulse that has been delayed and the second light pulse that has been modulated to interfere with each other in opposite phases or in the same phase, and outputs the quantum signal that has been decoded.

### (Supplementary Note 5)

The reception apparatus according to supplementary note 4, in which
the decoding means includes a Mach-Zehnder interferometer,
the plurality of detectors include first and second detectors,
the Mach-Zehnder interferometer includes:
a first path for delaying the quantum signal propagating therethrough;
a second path in which a phase modulator for phase-modulating the quantum signal propagating therethrough is provided;
a demultiplexer for demultiplexing the quantum signal into the first and second paths; and
a multiplexer/demultiplexer for outputting the quantum signal that has been decoded obtained by causing pieces of the quantum signal having passed through the first and second paths to interfere with each other in the opposite phases, to the first detector, and outputting the quantum signal that has been decoded obtained by causing pieces of the quantum signal having passed through the first and second paths to interfere with each other in the same phase, to the second detector.

### (Supplementary Note 6)

The reception apparatus according to supplementary note 1, further including decoding means for decoding the incident quantum signal into a plurality of optical signals indicating each state of a predetermined encoding base, in which
a plurality of the optical intensity modulation means are inserted into a plurality of paths through which the plurality of optical signals are incident on the plurality of detectors, respectively,
the plurality of optical intensity modulation means modulate intensities of the plurality of incident optical signals, respectively,
the plurality of optical signals that have been intensity-modulated are emitted to the plurality of detectors, respectively, and
the control means controls intensity modulation of the plurality of optical signals in the plurality of optical intensity modulation means in such a way that the plurality of optical signals are incident on the plurality of detectors in a period in which variation in detection efficiency of photons of the plurality of optical signals in the plurality of detectors falls within a predetermined range.

### (Supplementary Note 7)

The reception apparatus according to supplementary note 6, in which the plurality of optical intensity modulation means
causes the plurality of optical signals to pass in such a way that photons of the plurality of optical signals are incident on the plurality of detectors, in the period in which variation in detection efficiency of the photons of the plurality of optical signals in the plurality of detectors falls within the predetermined range, and
blocks the plurality of optical signals in such a way that the plurality of optical signals are not incident on the plurality of detectors, in the period in which variation in detection efficiency of the photons of the plurality of optical signals in the plurality of detectors is out of the predetermined range.

### (Supplementary Note 8)

The reception apparatus according to supplementary note 6 or 7, in which the control means controls intensity modulation of the plurality of optical signals in the plurality of optical intensity modulation means in such a way that periods in which the plurality of optical signals can be incident on the plurality of detectors are synchronized.

### (Supplementary Note 9)

The reception apparatus according to supplementary note 8, in which
the plurality of detectors include a first detector corresponding to a first bit of one encoding base and a second detector corresponding to a second bit of the one encoding base,
the plurality of optical intensity modulation means include first and second optical intensity modulation means inserted into incident paths of first and second optical signals to the first and second detectors, and
the control means controls intensity modulation of the first and second optical signals in the first and second optical intensity modulation means in such a way that periods in which the first and second optical signals can be incident on the first and second detectors are synchronized.

### (Supplementary Note 10)

The reception apparatus according to supplementary note 8, in which
the plurality of detectors include
a first detector corresponding to a first bit of a first encoding base,
a second detector corresponding to a second bit of the first encoding base,
a third detector corresponding to a third bit of a second encoding base, and
a fourth detector corresponding to a fourth bit of the second encoding base,
the plurality of optical intensity modulation means include first to fourth optical intensity modulation means inserted into incident paths of first to fourth optical signals to the first to fourth detectors, and
the control means controls intensity modulation of the first to fourth optical signals in the first to fourth optical intensity modulation means in such a way that periods in which the first to fourth optical signals can be incident on the first to fourth detectors are synchronized.

### (Supplementary Note 11)

The reception apparatus according to supplementary note 6 or 7, in which the control means controls intensity modulation of the plurality of optical signals in the plurality of optical intensity modulation means in such a way that periods in which the plurality of optical signals can be incident on the plurality of detectors have a hierarchical inclusion relationship.

### (Supplementary Note 12)

The reception apparatus according to supplementary note 11, in which
the plurality of detectors include a first detector corresponding to a first bit of one encoding base and a second detector corresponding to a second bit of the one encoding base,
the plurality of optical intensity modulation means include first and second optical intensity modulation means inserted into incident paths of first and second optical signals to the first and second detectors, and
the control means controls intensity modulation of the first and second optical signals in the first and second optical intensity modulation means in such a way that a period in which the first optical signal can be incident on the first detector include a period in which the second optical signal can be incident on the second detector.

### (Supplementary Note 13)

The reception apparatus according to supplementary note 11, in which
the plurality of detectors include
a first detector corresponding to a first bit of a first encoding base,
a second detector corresponding to a second bit of the first encoding base,
a third detector corresponding to a third bit of a second encoding base, and
a fourth detector corresponding to a fourth bit of the second encoding base,
the plurality of optical intensity modulation means include first to fourth optical intensity modulation means inserted into incident paths of first to fourth optical signals to the first to fourth detectors, and
the control means controls intensity modulation of the first to fourth optical signals in the first to fourth optical intensity modulation means in such a way that first to fourth periods in which the first to fourth optical signals can be incident on the first to fourth detectors have a hierarchical inclusion relationship.

### (Supplementary Note 14)

A quantum key distribution system including:
a transmission apparatus for transmitting a quantum signal for quantum key distribution; and
a reception apparatus for receiving the quantum signal,
in which the reception apparatus includes
optical intensity modulation means for intensity-modulating the quantum signal incident from the transmission apparatus,
photon detection means for detecting photons of the quantum signal that has been intensity-modulated by the optical intensity modulation means by any of a plurality of detectors, and
control means for controlling the intensity modulation of the quantum signal in the optical intensity modulation means in such a way that the quantum signal is incident on the plurality of detectors in a period in which variation in detection efficiency of the quantum signal in the plurality of detectors falls within a predetermined range.

### (Supplementary Note 15)

A method for receiving a quantum signal including:
intensity-modulating a quantum signal in such a way that the quantum signal is incident on a plurality of detectors in a period in which variation in detection efficiency of the quantum signal in the plurality of detectors falls within a predetermined range, the plurality of detectors detecting a photon of the quantum signal; and
detecting the quantum signal that has been intensity-modulated, by any of the plurality of detectors.

Some or all of the elements (such as constituents and functions) described in supplementary notes 2 to 13 subordinate to supplementary note 1 may be subordinate also to supplementary notes 14, and 15 with a subordinate relationship similar to that of supplementary notes 2 to 13. Some or all of the elements described in any Supplementary Note can be applied to various types of hardware, software, and recording means for recording software, systems, and methods.

What is claimed is:

1. A reception apparatus comprising:
an optical intensity modulator configured to intensity-modulate an incident quantum signal;
a photon detection apparatus configured to detect photons of the quantum signal that has been intensity-modulated by the optical intensity modulator by any of a plurality of detectors; and
a controller configured to control the intensity modulation of the quantum signal in the optical intensity modulator in such a way that the quantum signal is incident on the plurality of detectors in a period in which variation in detection efficiency of the quantum signal in the plurality of detectors falls within a predetermined range.

2. The reception apparatus according to claim 1, wherein
the quantum signal that has been intensity-modulated by the optical intensity modulator is incident on the photon detection apparatus, and
the optical intensity modulator
causes a quantum signal incident at a timing included in the period in which variation in detection efficiency of the quantum signal in the plurality of detectors falls within the predetermined range to pass to the photon detection apparatus, and
blocks a quantum signal incident at a timing not included in the period in which variation in detection efficiency of the quantum signal in the plurality of detectors falls within the predetermined range.

3. The reception apparatus according to claim 2, wherein the photon detection apparatus includes:
a decoder configured to decode the quantum signal received from the optical intensity modulator;
the plurality of detectors configured to detect photons of the quantum signal that has been decoded by the decoder; and
a signal processing unit configured to detect a bit of the quantum signal that has been decoded, based on detection results of photons by the plurality of detectors.

4. The reception apparatus according to claim 3, wherein
a phase of a light pulse included in the quantum signal incident on the optical intensity modulator is shifted by 0 or π in a first encoding base, and is shifted by π/2 or 3π/2 in a second encoding base, and
the decoder is an interferometer that allows a quantum signal to be incident thereon, the quantum signal including a first light pulse of which a phase has been modulated in advance and a second light pulse delayed from the first light pulse by a predetermined time, delays the first light pulse by the predetermined time and modulates a phase of the second light pulse, causes the first light pulse that has been delayed and the second light pulse that has been modulated to interfere with each other in opposite phases or in the same phase, and outputs the quantum signal that has been decoded.

5. The reception apparatus according to claim 4, wherein
the decoder includes a Mach-Zehnder interferometer,
the plurality of detectors include first and second detectors,
the Mach-Zehnder interferometer includes:
a first path configured to delay the quantum signal propagating therethrough;
a second path in which a phase modulator configured to phase-modulate the quantum signal propagating therethrough is provided;
a demultiplexer configured to demultiplex the quantum signal into the first and second paths; and
a multiplexer/demultiplexer configured to output the quantum signal that has been decoded obtained by causing pieces of the quantum signal having passed through the first and second paths to interfere with each other in the opposite phases, to the first detector, and output the quantum signal that has been decoded obtained by causing pieces of the quantum signal having passed through the first and second paths to interfere with each other in the same phase, to the second detector.

6. The reception apparatus according to claim 1, further comprising decoder configured to decode the incident quantum signal into a plurality of optical signals indicating each state of a predetermined encoding base, wherein
a plurality of the optical intensity modulators are inserted into a plurality of paths through which the plurality of optical signals are incident on the plurality of detectors, respectively,
the plurality of optical intensity modulators modulate intensities of the plurality of incident optical signals, respectively,
the plurality of optical signals that have been intensity-modulated are emitted to the plurality of detectors, respectively, and
the controller controls intensity modulation of the plurality of optical signals in the plurality of optical intensity modulators in such a way that the plurality of optical signals are incident on the plurality of detectors in a period in which variation in detection efficiency of photons of the plurality of optical signals in the plurality of detectors falls within a predetermined range.

7. The reception apparatus according to claim 6, wherein the plurality of optical intensity modulators
cause the plurality of optical signals to pass in such a way that photons of the plurality of optical signals are incident on the plurality of detectors, in the period in which variation in detection efficiency of the photons of the plurality of optical signals in the plurality of detectors falls within the predetermined range, and
block the plurality of optical signals in such a way that the plurality of optical signals are not incident on the plurality of detectors, in the period in which variation in detection efficiency of the photons of the plurality of optical signals in the plurality of detectors is out of the predetermined range.

8. The reception apparatus according to claim 6, wherein the controller controls intensity modulation of the plurality of optical signals in the plurality of optical intensity modulators in such a way that periods in which the plurality of optical signals can be incident on the plurality of detectors are synchronized.

9. The reception apparatus according to claim 8, wherein
the plurality of detectors include a first detector corresponding to a first bit of one encoding base and a second detector corresponding to a second bit of the one encoding base,
the plurality of optical intensity modulators include first and second optical intensity modulators inserted into incident paths of first and second optical signals to the first and second detectors, and
the controller controls intensity modulation of the first and second optical signals in the first and second optical intensity modulators in such a way that periods in which the first and second optical signals can be incident on the first and second detectors are synchronized.

10. The reception apparatus according to claim 8, wherein
the plurality of detectors include
a first detector corresponding to a first bit of a first encoding base,
a second detector corresponding to a second bit of the first encoding base,
a third detector corresponding to a third bit of a second encoding base, and
a fourth detector corresponding to a fourth bit of the second encoding base,
the plurality of optical intensity modulators include first to fourth optical intensity modulators inserted into incident paths of first to fourth optical signals to the first to fourth detectors, and
the controller controls intensity modulation of the first to fourth optical signals in the first to fourth optical intensity modulators in such a way that periods in which the first to fourth optical signals can be incident on the first to fourth detectors are synchronized.

11. The reception apparatus according to claim 6, wherein the controller controls intensity modulation of the plurality of optical signals in the plurality of optical intensity modulators in such a way that periods in which the plurality of optical signals can be incident on the plurality of detectors have a hierarchical inclusion relationship.

12. The reception apparatus according to claim 11, wherein
the plurality of detectors include a first detector corresponding to a first bit of one encoding base and a second detector corresponding to a second bit of the one encoding base,
the plurality of optical intensity modulators include first and second optical intensity modulators inserted into incident paths of first and second optical signals to the first and second detectors, and
the controller controls intensity modulation of the first and second optical signals in the first and second optical intensity modulators in such a way that a period in which the first optical signal can be incident on the first detector includes a period in which the second optical signal can be incident on the second detector.

13. The reception apparatus according to claim 11, wherein
the plurality of detectors include
a first detector corresponding to a first bit of a first encoding base,
a second detector corresponding to a second bit of the first encoding base,
a third detector corresponding to a third bit of a second encoding base, and
a fourth detector corresponding to a fourth bit of the second encoding base,
the plurality of optical intensity modulators include first to fourth optical intensity modulators inserted into incident paths of first to fourth optical signals to the first to fourth detectors, and
the controller controls intensity modulation of the first to fourth optical signals in the first to fourth optical intensity modulators in such a way that first to fourth periods in which the first to fourth optical signals can be incident on the first to fourth detectors have a hierarchical inclusion relationship.

14. A quantum key distribution system comprising:
a transmission apparatus configured to transmit a quantum signal for quantum key distribution; and
a reception apparatus configured to receive the quantum signal,
wherein the reception apparatus includes
an optical intensity modulator configured to intensity-modulate the quantum signal incident from the transmission apparatus,
a photon detection apparatus configured to detect photons of the quantum signal that has been intensity-modulated by the optical intensity modulator by any of a plurality of detectors, and
a controller configured to control the intensity modulation of the quantum signal in the optical intensity modulator in such a way that the quantum signal is incident on the plurality of detectors in a period in which variation in detection efficiency of the quantum signal in the plurality of detectors falls within a predetermined range.

15. A method for receiving a quantum signal comprising:
intensity-modulating a quantum signal in such a way that the quantum signal is incident on a plurality of detectors in a period in which variation in detection efficiency of the quantum signal in the plurality of detectors falls within a predetermined range, the plurality of detectors detecting a photon of the quantum signal; and
detecting the quantum signal that has been intensity-modulated, by any of the plurality of detectors.
